(19) United States
(12) Patent Application Publication
(10) Pub. No.: US 2017/0165955 A1
(43) Pub. Date: Jun. 15, 2017

(54) PRINTING METHOD AND PRINTING DEVICE

(71) Applicant: GT + W GMBH, DARMSTADT (DE)

(72) Inventors: ROBERT THIEME, DARMSTADT (DE); THOMAS OBERLE, DARMSTADT (DE); PATRICK SAUER, BEERFELDEN/OLFEN (DE)

(21) Appl. No.: 15/313,170

(22) PCT Filed: May 19, 2015
(86) PCT No.: PCT/IB2015/053675

§ 371 Date: Feb. 24, 2017

(30) Foreign Application Priority Data
May 22, 2014 (DE) DE102014107223.5

(51) Int. Cl. B41F 21/00; B41F 13/00

(52) U.S. Cl. CPC B41F 21/00; B41F 13/00

(57) ABSTRACT

A printing unit has a printing form cylinder, an impression cylinder opposite the printing form cylinder and at least one substrate carrier apparatus with which a printing substrate is moved through between the printing form cylinder and the impression cylinder, wherein the substrate is printed in a printing region between the two cylinders. The substrate carrier apparatus is moved linearly during a uniform rotation of the two cylinders along a linearly extending track, limited in length by a longitudinal extension of the printing unit. The substrate carrier apparatus is accelerated from a resting start position to an operating speed, to be reached upon reaching the printing region, the substrate carrier apparatus is moved at least in the printing region at constant speed, and the substrate carrier apparatus is decelerated after leaving the printing region to a resting end position on the track.

The present invention relates to a printing method with a printing device comprising at least one printing unit with at least one printing form cylinder, at least one impression cylinder arranged opposite the printing form cylinder and at least one substrate carrier apparatus, wherein the printing form cylinder and the impression cylinder are rotated in opposition to each other, at least one substrate is moved through between the printing form cylinder and the impression cylinder by means of the substrate carrier apparatus, and in the process the at least one substrate is printed in a printing region situated between the printing form cylinder and the impression cylinder by means of a gravure provided on a cylinder surface of the printing form cylinder or by means of a plate provided on a cylinder surface of the printing form cylinder. The invention furthermore relates to a printing device, which comprises at least one printing unit with at least one printing form cylinder, at least one impression cylinder arranged opposite the printing form cylinder and at least one substrate carrier apparatus, wherein the printing form cylinder and the impression cylinder are rotatable in opposition to each other and at least one substrate is movable through between the printing form cylinder and the impression cylinder by means of the substrate carrier apparatus in order to print the at least one substrate in a printing region situated between the printing form cylinder and the impression cylinder by means of a gravure provided on a cylinder surface of the printing form cylinder or by means of a plate provided on a cylinder surface of the printing form cylinder.

The document DE 10 2004 050 725 A1 discloses an offset printing device comprising a multitude of successively arranged working stations in which each sheet material is fixed to a sheet holding system and is transported through between a form cylinder and a counter-pressure cylinder in a conveying direction by means of an endlessly revolving conveyor at an ever constant speed. The working station comprises a transmitter/detector with which the position of the sheet holding system is recorded, processed as a signal and supplied to a machine control. The rotation speed of the form cylinder and/or the counter-pressure cylinder is controlled by means of the machine control in order to ensure a synchronous operation of the cylinders.

In order to achieve a qualitative and consistently good print quality, the form cylinder and the counter-pressure cylinder in the printing devices known from the prior art are formed with a large weight and are firmly installed in order to prevent a shifting during the printing process. In accordance with this, the form cylinder and the impression cylinder comprise a certain inertia relating to the speed adjustments required in document DE 10 2004 050 725 A, the result being that even when using the latest measurement electronics, no perfect synchronic adjustment of both cylinders can be realized, which in turn leads to a loss of accuracy when printing especially small structures, such as structures with measurements in the micrometer range.

The object of the present invention is to provide a printing device of the above-mentioned type with which an increased accuracy can be achieved when printing.

The object is firstly solved by means of a printing method of the above-mentioned type in which the substrate carrier apparatus is moved linearly during a uniform rotation movement of the printing form cylinder and of the impression cylinder along a linearly extending track, limited in length by a longitudinal extension of the printing unit, wherein the substrate carrier apparatus is accelerated from a resting start position to an operating speed which the substrate carrier apparatus has no later than in the printing region, the substrate carrier apparatus is moved at least in the printing region at constant speed, and the substrate carrier apparatus is decelerated after leaving the printing region to a resting end position on the track.

With the method according to the invention, not, as in the prior art, the speed of printing form cylinder and impression cylinder is changed, but the speed of the substrate carrier apparatus is changed in order to move through the substrate according to a predefined movement and thus printing process between the printing form cylinder and the impression cylinder. Unlike the relatively inert printing form cylinders and impression cylinders, the substrate carrier apparatus of the method according to the invention is formed so lightly that its speed can be changed virtually instantaneous and adjustments of position of the substrate carrier apparatus can thus be directly carried out.

The method according to the invention furthermore has the advantage that the printing device, on which the printing method is being carried out, can be set up in a space-saving way, since the track along which the substrate carrier apparatus is to be moved can overall be kept short. This, in turn, is possible because of the small weight of the substrate carrier apparatus, its acceleration and deceleration can take place with high accuracy in a short amount of time.

In a preferred embodiment of the method according to the invention, the position of the substrate carrier apparatus and/or the substrate per time, at least during the phase in which the substrate carrier apparatus is moved at constant speed, are monitored with at least one sensor, the measured actual positions of the sensor and the required positions of the sensor obtained from a movement curve predefined for the substrate carrier apparatus are compared by means of an evaluator, and the position, when determining a position deviation of the substrate carrier apparatus, is adjusted by means of a change of speed of the substrate carrier apparatus, wherein the rotation speed of the printing form cylinder and the impression cylinder are maintained.

Due to the sensor, position deviations can be immediately determined and instantaneously corrected by means of the interaction of sensor, evaluator, control device and linear motor. With this method, only the speed and/or the acceleration of the substrate carrier apparatus are changed, while the printing form cylinder and the impression cylinder continue to rotate at a constant speed, thus neither need to be accelerated nor decelerated. In the process, the total distance which the substrate carrier apparatus covers can be reduced due to the quick accelerating and decelerating processes and thus the assembly space of the used printing device can be minimized.

The object is furthermore solved by means of a printing device of the above-mentioned type in which the substrate carrier apparatus is movable linearly along a linearly extending track, limited in length by a longitudinal extension of the printing unit, wherein the track comprises a start position, an accelerating area, the printing region, a decelerating area and an end position, the substrate carrier apparatus is connected to a carriage operated by a linear motor traversable alongside the track by at least one suspension spring, and the linear motor comprises a control device with which the speed and/or acceleration of the substrate carrier apparatus is changeable according to its position on the track.

The suspension spring is elastic at least in the direction in which the impression cylinder presses against the substrate.

The printing device according to the invention comprises a substrate carrier apparatus that is quickly and reliably changeable in its speed, by whose change of speed an immediate reaction to position deviations of the substrate carrier apparatus or the thereto provided substrate is possible and can be promptly and accurately corrected. Due to the possibility of a quick and accurate track correction, errors during printing can be mostly prevented and a high reproducibility of the print results, even in a range smaller than 10 μm, can be provided.

Due to the possibility of quick speed changes of the substrate carrier apparatus, the courses which are used for the acceleration and deceleration of the substrate carrier apparatus on the linear track, can be designed relatively short, whereby the printing device according to the invention can be provided with an assembly space significantly smaller compared to that of the prior art.

In a preferred embodiment of the present invention, the printing device comprises at least one position sensor for permanently recording the position of the substrate carrier apparatus in at least one phase of constant speed of the substrate carrier apparatus and an evaluator connected to the control device of the linear motor for comparing the measured actual positions of the sensor and the required positions of the sensor from a movement curve predefined for the substrate carrier apparatus and for determining the resulting position deviations. By means of the sensor in connection with the evaluator, position deviations of the substrate carrier apparatus or the thereto incorporated at least one substrate are immediately recorded and instantaneously corrected by means of the control device in interaction with the linear motor.

It is particularly advantageous for the printing device according to the invention if the substrate carrier apparatus itself or with at least one applied substrate weighs less than 1 kg, preferably less than 0.5 kg, more preferably less than 0.3 kg. Thus, the substrate carrier apparatus comprises a particularly small inertia, whereby it can be accelerated and decelerated particularly fast and position deviations can be immediately compensated.

A particularly small weight and thus a high speed of carrying out movement correction of the substrate carrier apparatus are obtained with the present invention when the substrate carrier apparatus does not comprise a vacuum system for holding the substrate or when a vacuum system is used which is suspended on the at least one suspension spring.

The printing device according to the invention is particularly easily convertible if according to an embodiment of the invention the gravure of the gravure printing form cylinder or the plate of the flexo printing form cylinder is provided on a print form sleeve that is slideable onto a base cylinder of the printing form cylinder and the base cylinder is connected to a compressed air supply and compressed air outlets spread across the base cylinder surface are provided.

A preferable embodiment of the present invention, including its structure, function and advantages is explained in more detail in the following using figures, wherein

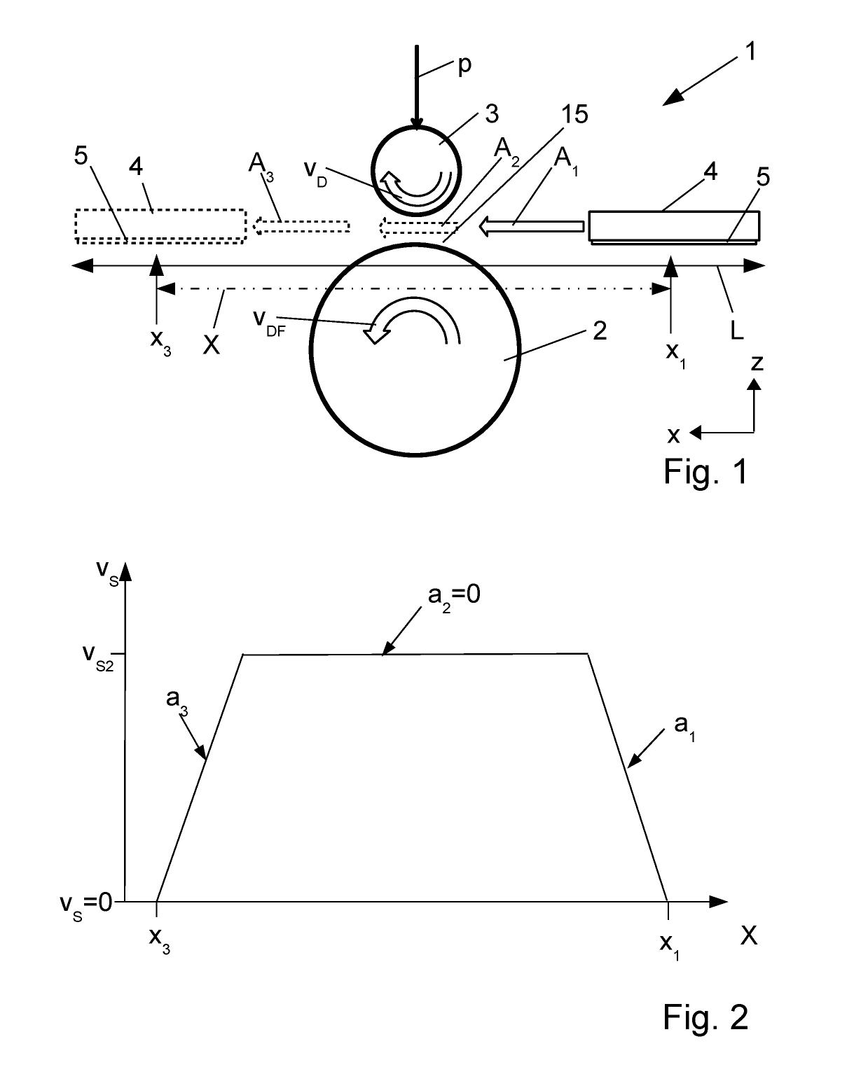

FIG. 1 schematically shows an embodiment of the printing device according to the invention in a frontal view;

FIG. 2 schematically shows a motion sequence of a substrate carrier apparatus of the printing device from FIG. 1 usable in an embodiment of the printing method according to the invention;

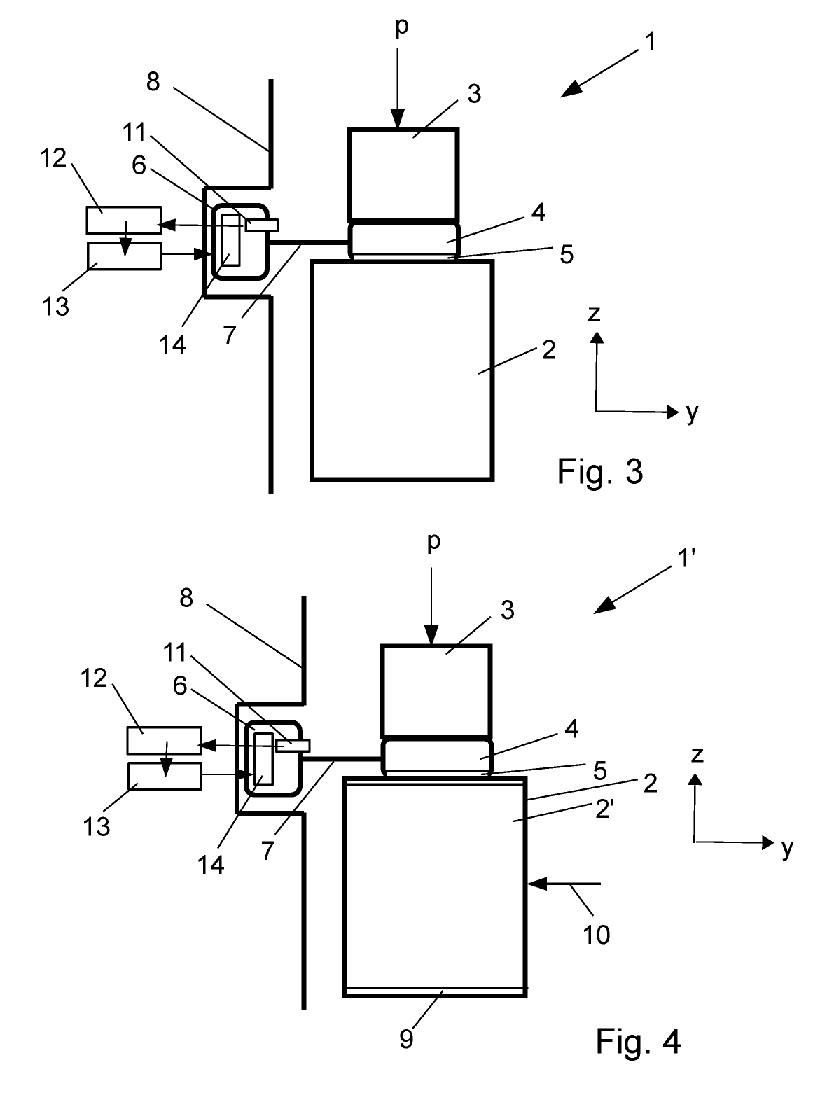

FIG. 3 schematically shows the printing device from FIG. 1 in a side view; and

FIG. 4 schematically shows another embodiment of the printing device according to the invention in a side view.

For reasons of clarity, not all details of the printing device and the printing method, such as paint application and paint removal mechanisms such as scrapers, electrical connections and connection lines, casing components or suchlike and/or a colouring device of a flexo printing form such as an anilox roll comprising chambered scrapers are depicted in the figures. The details that are not shown can be suitably supplemented by the person skilled in the art according to his special knowledge.

FIG. 1 schematically shows an embodiment of a printing unit of a printing device 1 according to the invention in a frontal view. The printing unit of the printing device 1 comprises a printing form cylinder 2 and an impression cylinder 3 arranged opposite the printing form cylinder 2. When operating the printing device 1, the printing form cylinder 2 and the impression cylinder 3 comprise rotation directions in opposition to each other. In the process, the printing form cylinder 2 rotates at a constant speed v_{DF} when operating the printing device 1, and the impression cylinder 3 rotates at a constant speed v_{D} when operating the printing device 1. Typically but not necessarily, the speeds v_{DF} and v_{D} are the same.

Preferably, a print column 15 is provided between the printing form cylinder 2 and the impression cylinder 3. However, this is not absolutely necessary.

The printing device 1 furthermore comprises a substrate carrier apparatus 4. During the printing process, the substrate carrier apparatus 4 holds at least one substrate 5 to be printed on. In the embodiment of FIG. 1, the substrate carrier apparatus 4 is formed plate-shaped, but can comprise another form in other embodiments of the invention. The substrate 5, which is for example formed of silicon, glass, paper, foil or another printable material, is fixed on a surface of the substrate carrier apparatus 4 that is directed downwards. In other, not depicted embodiments of the present invention, the printing form cylinder 2 can also be provided on top or sideways, while the impression cylinder 3 can be provided at the bottom or also sideways on the substrate carrier apparatus 4. Accordingly, the substrate 5 can also be provided on top or sideways on the substrate carrier apparatus 4. In this case, the expression “sideways” is not limited to an angular orientation.

The substrate 5 can for example be fixed to the substrate carrier apparatus 4 by means of adhering elements provided sideways. Other adhesive, aspirating or bonding means, which enable a reliable adhesion of the at least one substrate 5 on the substrate carrier apparatus 4, especially during the printing of the substrate 5 and with which an easy, non-damaging detaching of the substrate 5 from the substrate carrier apparatus 4 after the printing is possible, however, are also suitable for affixing the substrate 5 on the substrate carrier apparatus 4

The substrate carrier apparatus 4 can comprise at least one surface made of a soft, rubber-like material. Furthermore, the impression cylinder 3 can comprise a soft, rubber-like surface. Preferably, the printing unit is freely accessible from at least one side.

Even though it is not completely excluded for the invention, preferably no vacuum suction is used with the printing device 1 for affixing the substrate 5 on the substrate carrier apparatus 4, since such vacuum suction devices are usually associated with an increased weight. The substrate carrier apparatus 4 of the printing device 1 according to the invention is rather formed especially light. The light weight of the substrate carrier apparatus 4 can inter alia be achieved by a small size and/or thickness of the substrate carrier apparatus 4 and/or by using materials with a small weight, such as fibre composite, for producing the substrate carrier apparatus 4. Preferably, either the substrate carrier apparatus 4 itself or including the at least one substrate 5 weighs less than 1 kg, particularly preferable less than 500 g and in a favored embodiment of the invention less than 300 g.

On a cylinder surface of the printing form cylinder 2, a gravure is provided not depicted in more detail in the figures, with which the substrate 5 is printed. The printing form gravure can be formed electromechanical, as a direct laser gravure, a chemical gravure or another suitable gravure.

For printing the substrate 5, the substrate carrier apparatus 4 is moved through between the printing form cylinder 2 and the impression cylinder 3 along the arrows A₁, A₂, A₃. Thereby, the impression cylinder 3 pushes, as schematically illustrated by the arrow p, in FIG. 1 from above on the substrate carrier apparatus 4 and thus presses the substrate 5 against the gravure provided on the printing form cylinder 2.

The substrate carrier apparatus 4 with the thereto provided substrate 5 moves linearly along a linearly extending track X limited in length by a longitudinal extension L of the printing unit 1. As schematically shown in FIG. 2, the substrate carrier apparatus 4 is herein accelerated from a resting start position x₁ in an accelerating area up to a speed v_{S2} by means of an acceleration a₁, after that runs at a constant speed v_{S2} or with an acceleration a₂=0 through a printing region between the printing form cylinder 2 and the impression cylinder 3 in which the at least one substrate 5 is printed and is afterwards decelerated in a deceleration area by means of a negative acceleration a₃ to a resting end position x₃ in which the substrate carrier apparatus 4 is depicted as a dotted line in FIG. 1.

The acceleration and deceleration can, as schematically shown in FIG. 2, take place linearly. In other embodiments of the invention, the acceleration of the substrate carrier apparatus 4 can, however, also take place in form of a parabolic shape that is approaching initially fast and then gradually, preferably jerk-free, to the speed value v_{S2} and/or the deceleration of the substrate carrier apparatus 4 can take place in form of a movement curve that is decreasing initially slowly, preferably jerk-free, and then faster from v_{S2} to zero. The entire motion sequence on the track X is predefined for the substrate carrier apparatus 4 by a control device 13 of the printing device 1 shown in FIG. 3. The shown motion sequence can also take place in reverse direction that is, based on the position x₃ to the position x₁, preferably with reversed movement direction of the cylinders 2, 3. The movement direction of the substrate carrier apparatus 4 also changes if the arrangement of printing form cylinder 2 and the impression cylinder 3 is reversed or changed in its angular orientation.

In FIG. 3, the printing device 1 of FIG. 1 is schematically shown in a side view. As can be discerned from FIG. 3, the printing device 1 comprises at least one sensor 11. The sensor 11 is a position sensor, with which the respective position x of the substrate carrier apparatus 4 and/or the substrate 5 is permanently monitored on the track X per time at least during the phase in which the substrate carrier apparatus 4 is moved at the constant operating speed v₂. The position monitoring can also take place on the entire track X. The measurement results of the sensor 11, hence the respective actual positions of the sensor, are transferred to an evaluator 12 of the printing device 1 by the sensor 11. The evaluator 12 compares the measured actual positions of the sensor with the required positions of the sensor from a movement curve that is predefined for the substrate carrier apparatus 4 by the control device 13 and thus determines the subsequent position deviations. The evaluator 12 transfers the determined position deviations to the control device 13, which immediately adjusts the position of the substrate carrier apparatus 4 by acceleration or deceleration of the substrate carrier apparatus 4 according to the predefined motion sequence.

The entire motion sequence of the substrate carrier apparatus 4 is initiated by a linear motor 14. The linear motor 14 is controlled by the control device 13.

As can be seen in FIG. 3, the substrate carrier apparatus 4 is led one-sided on a carriage 6, which is traversable in linear fashion alongside the track X and is operated by a linear motor 14. The substrate carrier apparatus 4 is suspended on the carriage 6 by at least one suspension spring 7 and is moved along with the movement of the carriage 6. The suspension spring 7 is elastic at least in z-direction, that is, in the direction in which the impression cylinder 3 pushes against the substrate 5. Due to the elasticity of the suspension spring 7 and the pressure p of the impression cylinder 3, the substrate 5 is reliably pressed against the printing form cylinder 2 during the printing process, even though the weight of the substrate carrier apparatus 4 used according to the invention is very small compared to devices used in the prior art.

The small weight of the substrate carrier apparatus 4 used according to the invention, however, enables a very fast changeability of the speed v_{S} of the substrate carrier apparatus 4 in case of position deviations recorded by the sensor 11. The speed v_{S} of the substrate carrier apparatus 4 is much faster and more variably changeable with the printing device 1 according to the invention than the rotation speed of the printing form cylinder 2 and/or the impression cylinder 3 would be due to the existing inertia. As a result, the printing device 1 according to the invention works significantly more accurate than other printing devices from the prior art. For example, a cell-specific overprinting of several layers with an accuracy of <10 μm can be achieved by means of the printing device 1 according to the invention.

The small weight of the substrate carrier apparatus 4 also enables an overall very high processing speed during printing. Thus, the substrate carrier apparatus 4 can for example be moved through the printing region between the printing form cylinder 2 and the impression cylinder 3 at a speed v_{S2} of up to 3 m/s or also up to 5 m/s or also with a higher speed, without the printing accuracy suffering hereunder.

Another advantage of the printing device 1 according to the invention compared to the prior art consists in its low fluid consumption of for example less than 2 ml or also less than 1 ml per printing process.

Due to the, by means of the control device 13, definable limited motion sequence of the substrate carrier apparatus 4 alongside the track X limited in length, the installation space of the printing device 1 according to the invention can furthermore be significantly reduced over known printing devices.

FIG. 4 shows another embodiment of the printing device 1 according to the invention, wherein the same elements of the printing device V with the same reference signs like those of the printing device 1 according to the FIGS. 1 to 3 are indicated and to whose respectively corresponding description above regarding these elements is hereby fully referred.

In contrast to the printing device 1, the printing unit of the printing device V comprises a printing form cylinder 2 with a base cylinder 2′ and a printing form sleeve 9 that is slideable onto the base cylinder 2′, wherein the gravure of the gravure printing form or the plate of the flexo printing form is provided on an outer surface of the printing form sleeve 9. A compressed air supply 10 is provided on the base cylinder 2′. The base cylinder 2′ furthermore comprises compressed air supply outlets spread across the base cylinder surface by which the printing form sleeve 9 can be initially expanded in order to be slid easily onto the base cylinder 2′. If a printing pattern is to be changed, only the printing form sleeve 9 needs to be replaced in this embodiment of the invention.

The described method and the described device are particularly suitable as a gravure printing procedure or as a gravure printing device or as a flexo printing procedure or a flexo printing device. The surface of the printing form cylinder 2 is formed softly or rubber-like with the flexo printing procedure.

1-7. (canceled)

8. A printing method, comprising:
providing a printing device with at least one printing unit having at least one printing form cylinder, with at least one impression cylinder arranged opposite the printing form cylinder;
rotating the printing form cylinder and the impression cylinder in opposition to one another;
providing a substrate carrier apparatus for moving at least one substrate through between the printing form cylinder and the impression cylinder, and thereby printing the at least one substrate in a printing region located between the printing form cylinder and the impression cylinder by imprinting engravings provided on a cylinder surface of the printing form cylinder or an image die provided on a cylinder surface of the printing form cylinder;
during a uniform rotation movement of the printing form cylinder and the impression cylinder, moving the substrate carrier apparatus linearly along a linearly extending track that is limited in length by a longitudinal extension of the printing unit, and thereby accelerating the substrate carrier apparatus from a resting start position to an operating speed to be assumed by the substrate carrier apparatus no later than upon reaching the printing region, moving the substrate carrier apparatus at a constant operating speed at least in the printing region, and decelerating the substrate carrier apparatus after leaving the printing region to a resting end position on the track.

9. The printing method according to claim 8, which comprises:
providing a sensor and permanently monitoring a position of the substrate carrier apparatus and/or the substrate on the track (per time) at least during a phase in which the substrate carrier apparatus is moved at the constant operating speed;
comparing, with an evaluator, measured actual sensor positions with required sensor positions obtained from a motion sequence predefined for the substrate carrier apparatus by a control device; and
upon determining a position deviation of the substrate carrier apparatus, correcting the respective position by way of a change of speed of the substrate carrier apparatus while maintaining the rotation speeds of the printing form cylinder and the impression cylinder.

10. A printing device, comprising:
a printing unit with at least one printing form cylinder, at least one impression cylinder disposed opposite said printing form cylinder and rotatable in opposition to one another;
at least one substrate carrier apparatus configured to move at least one substrate through between said printing form cylinder and said impression cylinder, wherein the at least one substrate is printed in a printing region situated between said printing form cylinder and said impression cylinder by way an engraving on a cylinder surface of said printing form cylinder or an image die plate provided on a cylinder surface of said printing form cylinder;
a linearly extending track limited in length by a longitudinal extension of said printing unit, said track being formed with a start position, an acceleration area, the printing region, a deceleration area and an end position;
a carrier driven by a linear motor for moving said substrate carrier apparatus in linear fashion along the track by at least one spring suspension; and
a control device linked to, or integrated with, said linear motor for adjusting a speed and a acceleration of said substrate carrier apparatus according to a position of the substrate carrier apparatus on the track.

11. The printing device according to claim 10, which comprises:
at least one sensor disposed to permanently record the position of the substrate carrier apparatus at least during a phase of constant speed of the substrate carrier apparatus; and
an evaluation device connected to a control device for comparing recorded actual sensor positions with required sensor positions from a motion sequence predefined for the substrate carrier apparatus by the control device and for determining subsequently resulting position deviations.

12. The printing device according to claim 10, wherein said substrate carrier apparatus weighs less than 1 kilogram.

13. The printing device according to claim 12, wherein said substrate carrier apparatus together with at least one substrate attached thereto weighs less than 1 kilogram.

14. The printing device according to claim 10, wherein said substrate carrier apparatus does not comprise a vacuum system for holding the at least one substrate.

15. The printing device according to claim 10, which comprises a vacuum system suspended on said spring suspension for holding the at least one substrate.

16. The printing device according to claim 10, wherein said printing device is a gravure printing device and an engraving of said printing form cylinder is disposed on a printing form sleeve that is slideable onto a base cylinder of said printing form cylinder and said base cylinder is connected to a pressurized air supply and said base cylinder is formed with a plurality of spread-across pressurized air outlets.

17. The printing device according to claim 10, wherein said printing device is a flexography printing device and an image die plate of the printing form cylinder is disposed on a printing form sleeve that is slideable onto a base cylinder of said printing form cylinder and said base cylinder is connected to a pressurized air supply and said base cylinder is formed with a plurality of spread-across pressurized air outlets.
